(19) United States
(12) Patent Application Publication
(10) Pub. No.: US 2023/0171275 A1
(43) Pub. Date: Jun. 1, 2023

(54) ANOMALY DETECTION AND ONBOARD SECURITY ACTIONS FOR AN AUTONOMOUS VEHICLE

(71) Applicant: GM Cruise Holdings LLC, San Francisco, CA (US)

(72) Inventors: Christopher Valasek, Pittsburgh, PA (US); Collin Richard Mulliner, Brooklyn, NY (US); Charles Miller, St. Louis, MO (US)

(73) Assignee: GM Cruise Holdings LLC, San Francisco, CA (US)

(21) Appl. No.: 17/539,927

(22) Filed: Dec. 1, 2021

(51) Int. Cl. H04L 12/40; B60W 60/00

(52) U.S. Cl. CPC H04L 63/1425; H04L 63/1441; H04L 12/40; B60W 60/00188; H04L 2012/40273; H04L 2012/40215

(57) ABSTRACT

An onboard security system for an autonomous vehicle (AV) can detect and respond to anomalies in the AV. The onboard security system may include one or more network anomaly detectors to detect unexpected changes to traffic on a local network of the AV, and one or more process anomaly detectors to detect unexpected changes to software processes running on the AV. If an anomaly is detected, an anomaly response system may classify the anomaly and determine a maneuver for the AV to perform, e.g., to pull over and stop the AV.

### TECHNICAL FIELD OF THE DISCLOSURE

The present disclosure relates generally to autonomous vehicles and, more specifically, to methods and systems for detecting and responding to onboard anomalies in autonomous vehicles.

### BACKGROUND

Autonomous vehicles (AVs) include a variety of connected devices and systems that enable the AV to drive autonomously. For example, AVs often include multiple sensor systems (e.g., cameras, radar, and lidar), computers running various software processes (e.g., image detection, routing, path planning), and components for controlling AV movement (e.g., engine control, brake control, steering control). Various hardware and software components communicate over internal networks on the AV, e.g., to exchange data and transmit instructions. In addition, AVs may be connected to the Internet or another network outside of the AV, e.g., to receive instructions from and send updates to an AV fleet management system.

Intrusions into the internal networks or processes can disrupt AV functionality. For example, a malicious actor may cause a disruption to a particular device on the AV, to a software process executed on the AV, or to an internal AV network. The disruption may be carried out locally, e.g., by an actor installing hardware or software within the AV, or remotely, e.g., by an actor transmitting code to the AV through the external network.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating a system, including an example AV that may implement an onboard security system, according to some embodiments of the present disclosure;

FIG. 2 is a block diagram illustrating various components that may be included in an AV, according to some embodiments of the present disclosure;

FIG. 3 is a block diagram illustrating various components that may be included in an onboard security system implemented on an AV, according to some embodiments of the present invention; and

FIG. 4 is a flow chart of a process for detecting and responding to an anomaly on the AV, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

AVs rely on complex hardware and software systems to perform autonomous driving. For example, an AV may have various onboard sensors systems that gather data about the AV's current behavior and the environment around the AV. AVs also execute a large number of software processes, including processes to analyze data from the onboard sensors, and processes to make driving decisions based on the analyzed data. AVs further include various control systems that control driving and other functionality. Disruptions to the hardware components on the AV or the software processes executing on the AV can compromise an AV's ability to perform autonomous driving.

In some cases, evidence of such disruptions may be observed on internal AV networks that components of the AV use to communicate with each other. For example, various sensor systems on the AV may be connected to a local Ethernet network and transmit data over the Ethernet network, e.g., to one or more devices for processing the captured sensor data. As another example, components for controlling motion-related systems (e.g., engine control, steering, and braking) may be connected to a local control area network (CAN). The data transmitted over these internal networks may have expected patterns. For example, a certain sensor, having a known network address, may send data packets at a predicted frequency to one or more known destination addresses. Because all the components on a local AV network are known, and their communication patterns are predictable, a deviation from the expected network traffic patterns may indicate a disruption within the AV, such as an intrusion on the local network or a disruption to a particular component on the network.

As another example, software processes executing on the AV may be expected to follow predictable patterns. For example, a particular software process may access data or instructions at an expected cadence or from an expected file location. As another example, a software process may write data to a log file at an expected file location and at an expected frequency. If a software process exhibits a pattern of reads or writes that differs from the expected pattern, this may indicate a disruption to the software process.

As described herein, an AV may include an onboard security system to detect and respond to disruptions in local AV networks, software processes, or other types of anomalies. The onboard security system may include one or more anomaly detectors that detect anomalies, such as deviations from expected patterns, on the AV. For example, a network anomaly detector may be coupled to an internal network of the AV (e.g., the Ethernet network or the CAN) and monitor traffic across the internal network. If the network anomaly detector detects a deviation from the expected network traffic, the network anomaly detector may output an alert. As another example, a process anomaly detector may observe a software process (e.g., a self-driving software stack, or a sensor data analysis process), and if the process anomaly detector detects a deviation from the expected execution process, the process anomaly detector may output an alert.

The onboard security system may also include an anomaly response system that receives alerts from the anomaly detectors. The anomaly response system may classify the anomaly by type or impact of the anomaly, e.g., whether the anomaly may affect the self-driving functionality of the AV. The anomaly response system may then determine a maneuver for the AV to perform in response to the anomaly. For example, if the anomaly response system classifies an anomaly as higher risk (e.g., impacting functionality of a key software process), the anomaly response system may determine that the AV should stop immediately. If the anomaly response system classifies an anomaly as benign (e.g., a redundant sensor system temporarily stopped transmitting data), the anomaly response system may determine that the AV should return to a maintenance facility when convenient, e.g., after the AV has completed a current task.

The anomaly response system may output the determined maneuver to the AV's self-driving system. The self-driving system may include a software process or set of software processes that may determine a path for the AV and may instruct the motion-related systems of the AV to drive along the determined path. The self-driving system may plan the AV's path based on the maneuver indicated by the anomaly response system and instruct the motion-related systems accordingly. The self-driving system may also consider other factors in determining instructions for the motion-related systems. For example, if the anomaly response system indicates that the AV should stop immediately, but the self-driving system determines that the AV is in the middle of an intersection, the self-driving system may instruct the engine/motor and steering systems to pull out of the intersection, pull over, and then stop, rather than stop in the middle of the intersection.

Embodiments of the present disclosure provide an onboard security system for an AV. The onboard security system includes a local network anomaly detector to detect an anomaly in traffic transmitted over a local network of the AV; a process anomaly detector to detect an anomaly in a software process executed on a computer of the AV; and an anomaly response system to receive an anomaly signal indicating an anomaly from one or more of the local network anomaly detector and the process anomaly detector; and transmit a path signal to a self-driving system of the AV based on the anomaly, the path signal instructing the self-driving system to alter a planned path of the AV.

Further embodiments of the present disclosure provide a method for a method for stopping an AV in response to detecting an onboard anomaly, and a computer-readable medium for performing the method. The method includes receiving, from one of a plurality of anomaly detectors, an anomaly signal indicating a detected anomaly, the plurality of anomaly detectors including one of a network anomaly detector to detect an anomaly on a local network of the AV and a process anomaly detector to detect an anomaly in a software process of the AV; classifying the anomaly based on the received anomaly signal indicating the detected anomaly; and transmitting a path signal to a self-driving system of the AV based on the anomaly, the path signal instructing the self-driving system to alter a planned path of the AV.

As will be appreciated by one skilled in the art, aspects of the present disclosure, in particular aspects of onboard anomaly detection and response, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the following description and the claims.

### Example AV System

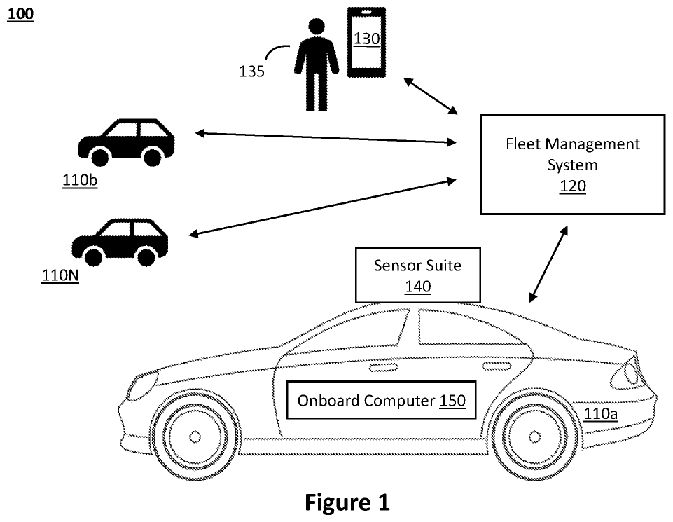

FIG. 1 is a block diagram illustrating a system 100 including an example AV that may implement an onboard security system, according to some embodiments of the present disclosure. The system 100 may include a fleet of autonomous vehicles (AVs) 110, including AV 110a, AV 110b, and AV 110N, a fleet management system 120, and a user device 130. For example, a fleet of AVs may include a number N of AVs, e.g., AV 110a through AV 110N. AV 110a may include a sensor suite 140 and an onboard computer 150. AVs 110b through 110N may also include the sensor suite 140 and onboard computer 150. A single AV in the fleet is referred to herein as AV 110, and the fleet of AVs is referred to collectively as AVs 110.

The AV 110 may be a fully autonomous automobile, but may additionally or alternatively be any semi-autonomous or fully autonomous vehicle; e.g., a boat, an unmanned aerial vehicle, a self-driving car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle.

The AV 110 may include a throttle interface that controls an engine throttle, motor speed (e.g., rotational speed of electric motor), or any other movement-enabling mechanism; a brake interface that controls brakes of the AV 110 (or any other movement-retarding mechanism); and a steering interface that controls steering of the AV 110 (e.g., by changing the angle of wheels of the AV 110). The AV 110 may additionally or alternatively include interfaces for control of any other vehicle functions, e.g., windshield wipers, headlights, turn indicators, air conditioning, etc.

The AV 110 includes a sensor suite 140, which includes a computer vision (“CV”) system, localization sensors, and driving sensors. For example, the sensor suite 140 may include photodetectors, cameras, radar (radio detection and ranging), sonar (sound detection and ranging), lidar (light detection and ranging), GPS (global positioning system) sensors, wheel speed sensors, inertial measurement units (IMUS), accelerometers, microphones, strain gauges, pressure monitors, barometers, thermometers, altimeters, etc. The sensors may be located in various positions in and around the AV 110.

An onboard computer 150 is connected to the sensor suite 140 and functions to control the AV 110 and to process sensed data from the sensor suite 140 and/or other sensors in order to determine the state of the AV 110. Based upon the vehicle state and programmed instructions, the onboard computer 150 modifies or controls behavior of the AV 110. For example, the onboard computer 150 maneuvers the AV 110 according to routing selections determined by an onboard or remote navigation system.

The onboard computer 150 is preferably a general-purpose computer adapted for I/O communication with vehicle control systems and sensor suite 140, but may additionally or alternatively be any suitable computing device, or a group of computing devices. The onboard computer 150 may transmit data to and receive data from other AV components via one or more local networks on the AV. The onboard computer 150 is preferably connected to the Internet via a wireless connection (e.g., via a cellular data connection). Additionally or alternatively, the onboard computer 150 may be coupled to any number of wireless or wired communication systems.

The onboard computer 150 and/or other onboard computing devices may implement an onboard security system for detecting anomalies in the AV 110. For example, the onboard computer 150 may include one or more anomaly detectors, such as a network anomaly detector for detecting anomalies in traffic transmitted across a network coupled to the onboard computer 150, and/or a process anomaly detector for detecting anomalies in a software process executed by the onboard computer 150. In some embodiments, one or more anomaly detectors may be implemented by other devices on the AV 110. The onboard computer 150 may further include an anomaly response system that may receive anomaly alerts from the anomaly detector(s). In response to receiving an anomaly alert, the anomaly response system may instruct a self-driving system (which may also be executed at least in part by the onboard computer 150) to alter a planned path of the AV 110, e.g., to stop the AV.

The fleet management system 120 manages the fleet of AVs 110. The fleet management system 120 may manage a service that provides or uses the AVs 110, e.g., a service for providing rides to users with the AVs 110, or a service that delivers items, such as prepared foods, groceries, or packages, using the AVs 110. The fleet management system 120 may select an AV from the fleet of AVs 110 to perform a particular service or other task and instruct the selected AV (e.g., AV 110a) to autonomously drive to a particular location (e.g., a pickup address or a delivery address). The fleet management system 120 may select a route for the AV 110 to follow. The fleet management system 120 also may manage fleet maintenance tasks, such as charging and servicing of the AVs 110.

As shown in FIG. 1, each of the AVs 110 may communicate with the fleet management system 120. The AVs 110 and fleet management system 120 may connect over a public network, such as the Internet. More specifically, the fleet management system 120 may receive and transmit data via one or more appropriate devices and network from and to the AV 110, such as by wireless systems, such as a wireless local area network (WLAN) (e.g., an IEEE 802.11 based system), a cellular system (e.g., a wireless system that utilizes one or more features offered by the 3rd Generation Partnership Project (3GPP), including General Packet Radio Service (GPRS)), and the like. If the anomaly response system implemented by the onboard computer 150 receives information describing an anomaly from an anomaly detector, the anomaly response system may cause the AV 110 to transmit an alert over the wireless network to the fleet management system 120.

The user device 130 may be a personal device of the user 135, e.g., a smartphone, tablet, computer, or other device for interfacing with a user of the fleet management system 120. The user device 130 may provide one or more applications (e.g., mobile device apps or browser-based apps) with which the user 135 can interface with a service that provides or uses AVs. The service, and the AVs 110 associated with the service, may be managed by the fleet management system 120, which may also provide the application to the user device 130. In other embodiments, the service may be managed by a separate system (e.g., a food delivery service) that relies on the AV fleet for some or all of its transportation tasks and interacts with the fleet management system 120 to arrange transportation tasks.

### Example AV Components

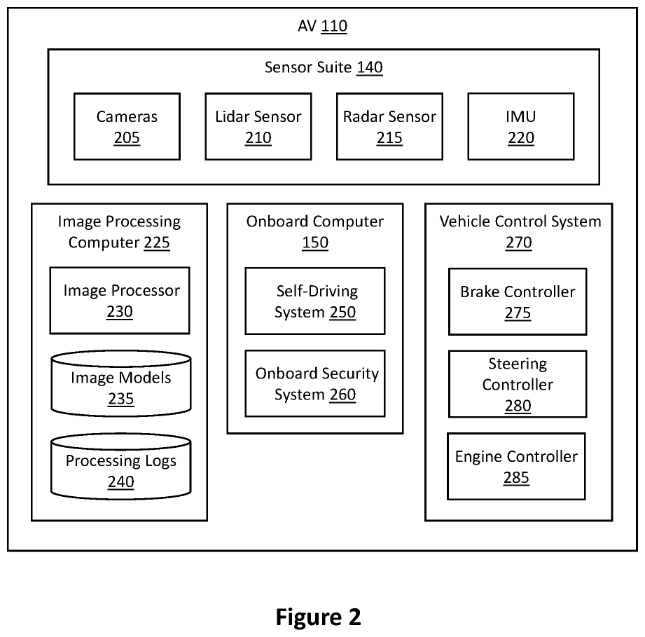

FIG. 2 is a block diagram illustrating various components that may be included in an AV 110, according to some embodiments of the present disclosure. The sensor suite 140, shown in FIG. 1, may include cameras 205, a lidar sensor 210, a radar sensor 215, and an IMU 220. An example image processing computer 225 may include an image processor 230, image models 235, and processing logs 240. The onboard computer 150, also shown in FIG. 1, includes a self-driving system 250 and an onboard security system 260. The AV 110 may further include a vehicle control system 270, which may include various vehicle controllers, such as a brake controller 275, a steering controller 280, and an engine controller 285. This block diagram includes multiple example components of an AV 110, but may not show every component of an AV. In alternative configurations, different and/or additional components may be included in the AV 110. Furthermore, functionality attributed to one component of the AV 110 may be accomplished by a different component included in the AV 110 or a different system than those illustrated. For example, the components of the image processing computer 225 may be included in the main onboard computer 150, or the onboard security system 260 may be implemented by a separate computing device.

The cameras 205 can capture images of the environment around the AV 110. The sensor suite 140 may include multiple cameras 205 to capture different views, e.g., a front-facing camera, a back-facing camera, and side-facing cameras. The cameras 205 may be implemented using high-resolution imagers with fixed mounting and field of view. One or more cameras 205 may capture light at different frequency ranges. For example, the sensor suite 140 may include one or more infrared cameras and/or one or more ultraviolet cameras in addition to visible light cameras.

The lidar sensor 210 can measure distances to objects in the vicinity of the AV 110 using reflected laser light. The lidar sensor 210 may be a scanning lidar that provides a point-cloud of the region scanned. The lidar sensor 210 may have a fixed field of view or a dynamically configurable field of view.

The radar sensor 215 can measure ranges and speeds of objects in the vicinity of the AV 110 using reflected radio waves. The radar sensor 215 may be implemented using a scanning radar with a fixed field of view or a dynamically configurable field of view. The radar sensor 215 may include one or more articulating radar sensors, long-range radar sensors, short-range radar sensors, or some combination thereof.

The IMU 220 can measure the specific force (e.g., the acceleration) and angular speed of the AV 110. The IMU 220 may include one or more accelerometers and/or one or more gyroscopes. The IMU 220 may be coupled to an inertial navigation system (not shown in FIG. 2) that can derive additional data, e.g., linear and velocity of the AV 110, based on data captured by the IMU 220. The data from the IMU 220 and/or inertial navigation system may be used in combination with a GPS device (not shown in FIG. 2) and/or other location tracking systems to determine a precise location of the AV 110, as well as the speed, turn rate, heading, and acceleration of the AV 110. In some embodiments, the data from the IMU 220 and/or GPS may further be combined with data from one or more wheel speed sensors or other onboard sensors for assessing movement and location of the AV 110.

The onboard computer 150 and/or other dedicated sensor data processing devices may be configured to process data from the sensor suite 140. As one example, the AV 110 may include an image processing computer 225, which may include an image processor 230 and image models 235 used to analyze image data captured by the cameras 205. More specifically, the image processor 230 may retrieve image data from the cameras 205 and process the image data to identify objects in the environment of the AV 110. For example, the image processor 230 may detect other vehicles, pedestrians, animals, buildings, road signs, traffic lights, cones, and other types of objects in the environment of the AV 110. The image processor 230 may rely on various image models 235, e.g., machine-learned models, to detect and/or classify objects in the environment of the AV 110. The image processor 230 may output image processing logs 240 describing the activities and/or results of the image processor 230.

While an example image processing computer 225 is illustrated in FIG. 2, it should be understood that the AV 110 may process data from other sensors in a similar manner. For example, other dedicated processing devices, the image processing computer 225, or the onboard computer 150 may include similar components for processing data from other sensors. For example, a dedicated lidar processing computer may include a lidar processor, lidar models, and lidar processing logs for processing data produced by the lidar sensor 210. Alternatively, these lidar processing components may be included in the image processing computer 225 or the onboard computer 150. Alternatively, such data processing functionalities may be distributed across multiple computers in the AV 110 and/or computers in communication with the AV 110. Furthermore, the onboard computer 150 or a separate data fusion computing device may additionally or alternatively have one or more fusion components for fusing raw or processed data from the sensor suite 140.

The onboard computer 150 may be a main computer for controlling the AV 110 based on input from other components, such as the sensor suite 140 and image processing computer 225. The self-driving system 250 may determine a path for the AV 110 based on various inputs. For example, the self-driving system 250 may have a path planning module that plans a path for the AV 110 based on raw and/or processed data from the sensor suite 140 (e.g., data output by the image processor 230). This may include locations of other vehicles, traffic control signals and signs, pedestrians, bicycles, etc. The path planning module may predict pathways of moving objects, or receive pathway predictions provided by a separate module (e.g., a path prediction module). The path planning module or path prediction module may reference right-of-way rules that regulate behavior of vehicles, bicycles, pedestrians, or other objects to predict the pathways of moving objects.

The path planning module may further determine the path for the AV 110 based on navigation information (e.g., a description of a planned route or the address of a destination). The path planning module may also reference map data, which may include detailed information about the local area, such as the known locations and boundaries of driving lanes and other known or expected features in the environment of the AV 110. The path planning module may also consider the current state of the AV 110 when planning the path, e.g., the AV's current speed, turn rate, heading, and acceleration. The path planning module may further consider data describing the current task assigned to the AV 110, e.g., whether the AV 110 has passengers or delivery items onboard.

The planned path may include direction, speed, and acceleration for the AV 110. After determining the path for the AV 110, the self-driving system 250 may transmit instructions to one or more components of the vehicle control system 270 to cause the AV 110 to travel along the determined path. The vehicle control system 270 may include various movement-related vehicle controllers. In the example shown in FIG. 2, the vehicle control system 270 includes a brake controller 275, which may control the brakes of the AV 110 (or any other movement-retarding mechanism); a steering controller 280, which may control steering of the AV 110 (e.g., by changing the angles of one or more of the wheels of the AV 110); and an engine controller 285, which may control the engine throttle, motor speed (e.g., rotational speed of an electric motor), or any other movement-enabling mechanism. For example, if the AV 110 is approaching a stop sign, the self-driving system 250 may instruct the brake controller 275 to stop the AV 110. If the AV 110 is to turn right after the stop sign, the self-driving system 250 may then instruct the steering controller 280 to angle the front wheels toward the right and instruct the engine controller 285 to move the AV 110 through the intersection.

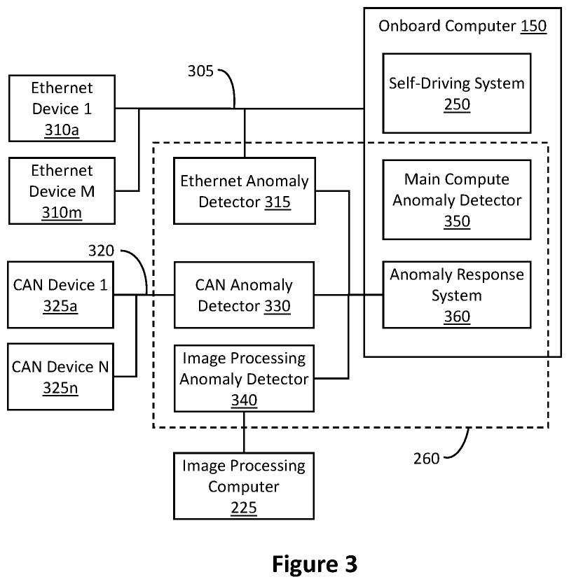

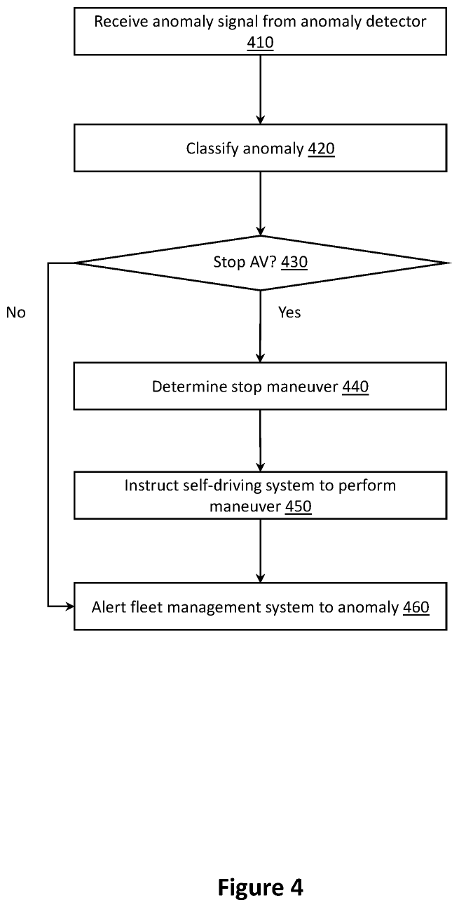

The onboard security system 260 may detect anomalies within systems or components of the AV 110. For example, the onboard security system 260 may detect anomalies in data traffic sent over a local Ethernet network, to which various components of the sensor suite 140 may be coupled. As another example, the onboard security system 260 may detect anomalies in software processes, e.g., processes performed by the image processor 230 and/or self-driving system 250. In response to detecting an anomaly, the onboard security system 260 may classify the anomaly, e.g., by type or severity. In some cases, the onboard security system 260 may instruct the self-driving system 250 to alter a planned path of the AV 110. An example implementation of the onboard security system 260 is shown in FIG. 3, and an example process that may be performed using the onboard security system 260 is shown in FIG. 4. While the onboard security system 260 is illustrated as being implemented on the onboard computer 150, in some embodiments, some or all of the onboard security system 260 may be implemented by other computing devices. For example, as illustrated in FIG. 3, some of the anomaly detectors may be implemented outside the onboard computer 150.

As noted above, the self-driving system 250 determines a path for the AV 110 based on various inputs. These inputs may include instructions from the onboard security system 260. If the self-driving system 250 receives an instruction from the onboard security system 260 to stop the AV 110, the self-driving system 250 may consider the instruction from the onboard security system 260 in conjunction with various other inputs in determining when and where to stop the AV 110. These other inputs may include the state of the AV 110 (e.g., speed, turn rate, heading, acceleration); the current task assigned to the AV 110 (e.g., whether the AV 110 is currently transporting a passenger, or whether the AV 110 is currently transporting a delivery load); the type of roadway the AV 110 is on (e.g., a highway or a surface road); the location of the AV 110 along the roadway (e.g., which lane the AV 110 is in, whether the AV 110 is near or in an intersection); and the locations and behaviors of other vehicles, bicycles, pedestrians, etc. around the AV 110.

In some embodiments, the self-driving system 250 receives a determined maneuver from the onboard security system 260. Example maneuvers may include stopping abruptly, pulling over to a shoulder or other stopping lane and stopping, or pulling over to a legal parking spot and stopping. The self-driving system 250 may determine whether the AV 110 can perform the instructed maneuver based on the various inputs mentioned above. As an example, if the AV 110 is driving in a center lane of a busy highway at 60 mph, and the self-driving system 250 receives an instruction from the onboard security system 260 to stop immediately, the self-driving system 250 may balance this instruction against the implications of stopping along a busy highway and determine that the AV 110 should first navigate to the highway shoulder, and then stop along the shoulder. On the other hand, if the AV 110 is driving at a low speed on a low-traffic roadway, the self-driving system 250 may determine to abruptly stop the AV 110 in the roadway, or swiftly pull over toward a side of the roadway and stop the AV 110.

As another example, if the self-driving system 250 receives an instruction from the onboard security system 260 to navigate to a maintenance facility, the self-driving system 250 may immediately update the path to navigate to the maintenance facility. However, if the self-driving system 250 determines that the AV 110 currently is driving a passenger or delivery item to a destination location, the self-driving system 250 may maintain the current path to complete the current task, and then navigate the AV 110 to the maintenance facility.

As another example, if the AV 110 is currently stopped and receives an instruction from the onboard security system 260 to stop, the self-driving system 250 may determine to stay in its current location (i.e., not move from its current location). Alternatively, if the AV 110 is stopped at a location not suitable for long-term stopping (e.g., at an intersection), the self-driving system 250 may determine to move the AV 110 to a more suitable long-term stopping or parking location, such as a parking spot or a shoulder.

In some embodiments, the onboard security system 260 may instruct the self-driving system 250 to continue driving but to follow one or more rules. For example, the onboard security system 260 may instruct the self-driving system 250 to not exceed a certain speed (e.g., 25 mph), or to not perform certain types of maneuvers (e.g., the AV 110 should not drive in reverse if the onboard security system 260 determines that a rear-facing sensor has been compromised).

In some embodiments, the self-driving system 250 and/or other systems on the AV 110 provides some information describing the state of the AV 110, environment of the AV 110, and/or other inputs to the onboard security system 260, and the onboard security system 260 determines a maneuver for the AV 110 based on the input from the self-driving system 250. For example, the onboard security system 260 may receive a signal indicating that a passenger is in the AV 110. Based on this information and data describing a particular detected anomaly, the onboard security system 260 may determine to make a soft stop (e.g., pulling the AV 110 over to the side of the road and stopping). On the other hand, if no passenger were in the AV 110, the onboard security system 260 may determine to make an abrupt stop in response to the same detected anomaly. If the onboard security system 260 considers AV 110 state and environment information when determining the maneuver, the self-driving system 250 may or may not consider this information in conjunction with the maneuver instructed by the onboard security system 260 when planning a path for the AV 110.

### Example Onboard Security System

FIG. 3 is a block diagram illustrating various components that may be included in the onboard security system 260 implemented on an AV 110, according to some embodiments of the present invention. In this example, the onboard security system 260 includes an Ethernet anomaly detector 315, a CAN anomaly detector 330, an image processing anomaly detector 340, a main compute anomaly detector 350, and an anomaly response system 360. In alternative configurations, different, fewer, and/or additional components may be included in the onboard security system 260. For example, different or additional anomaly detectors may be included, e.g., anomaly detectors for different types of networks, for one or more portion of a network (e.g., an anomaly detector for a camera portion of the Ethernet network), or different processes (e.g., an anomaly detector for a lidar processing module or a radar processing module). Functionality attributed to one component of onboard security system 260 may be accomplished by a different component included in the AV 110 or a different system than those illustrated. Furthermore, the components of the onboard security system 260 may be arranged differently than shown in FIG. 3, e.g., the anomaly response system 360 may be executed by a separate security computing device rather than the onboard computer 150, or one or more of the anomaly detectors may be executed by the same or a different security computing device.

The Ethernet anomaly detector 315 is coupled to an Ethernet network 305. Various Ethernet-enabled components in the AV 110 are also coupled to the Ethernet network 305. In the example shown in FIG. 3, the Ethernet network 305 is coupled to M Ethernet devices 310, e.g., Ethernet device 1 310a through Ethernet device M 310m. The Ethernet devices 310 may include one or more sensor systems, e.g., the cameras 205, the lidar sensor 210, the radar sensor 215, and the IMU 220 shown in FIG. 2. The onboard computer 150 may also be coupled to the Ethernet network 305. While not specifically shown in FIG. 3, the image processing computer 225 may also be coupled to the Ethernet network 305, e.g., to receive raw image data from the cameras 205 and transmit processed data to the self-driving system 250 on the onboard computer 150.

The Ethernet anomaly detector 315 may be configured to monitor network traffic transmitted over the Ethernet network 305 and to detect an anomaly in the network traffic. For example, the Ethernet anomaly detector 315 may access an Ethernet network model describing expected traffic on the Ethernet network 305. Across the fleet of AVs 110, each AV 110 may have the same set of Ethernet devices 310 connected to the Ethernet network 305, and the traffic transmitted over the Ethernet network 305 well-characterized. For example, the Ethernet network model may describe expected traffic to and/or from one or more devices on the Ethernet network, e.g., sender and/or recipient network addresses, size of data packets, rate of transmission, etc. As one particular example, the Ethernet network model may include data indicating that each of the cameras 205 (each having a known network address) is expected to transmit a data packet to the image processing computer 225 (also having a known network address) every tenth of a second.

If the Ethernet anomaly detector 315 detects a change from the expected traffic patterns (e.g., additional or fewer data packets than expected, or data traveling between a pair of devices or addresses that is not expected), the Ethernet anomaly detector 315 may transmit an anomaly signal to the anomaly response system 360. The anomaly signal may indicate that an anomaly was detected on the Ethernet network 305. In some embodiments, the anomaly signal may describe the anomaly, e.g., the type of anomaly (e.g., whether unexpected network traffic was detected or expected network traffic was not observed), the device or devices involved (e.g., the device transmitting and/or receiving unexpected network traffic), the frequency and/or duration of the anomaly (e.g., whether the unusual traffic was temporary or is ongoing), or other information. In some embodiments, the Ethernet anomaly detector 315 may filter certain low-level anomalies, e.g., if a single expected packet was not observed, but expected network traffic has resumed, the Ethernet anomaly detector 315 may not signal this to the anomaly response system 360. For example, the Ethernet anomaly detector 315 may signal the anomaly after observing at least a threshold number of dropped packets, or at least a threshold number of unexpected packets. The Ethernet anomaly detector 315 may have different thresholds for different types of anomalies, e.g., a lower threshold for unexpected packets to the onboard computer 150 than to the image processing computer 225.

The CAN anomaly detector 330 may be coupled to a CAN 320. Various CAN-connected components in the AV 110 may also be coupled to the CAN 320. In the example shown in FIG. 3, the CAN 320 is coupled to N CAN devices 325, e.g., CAN device 1 325a through CAN device N 325m. The CAN devices 325 may include one or more vehicle controllers, e.g., the brake controller 275, the steering controller 280, and the engine controller 285 shown in FIG. 2. The onboard computer 150 (e.g., the self-driving system 250) may also be coupled to the CAN 320. In some embodiments, the onboard computer 150 may not be directly connected to the CAN 320, but instead, is in communication with the CAN 320 via an intermediary device not shown in FIG. 3.

The CAN anomaly detector 330 may be configured to monitor network traffic transmitted over the CAN 320 and to detect an anomaly in the network traffic. For example, the CAN anomaly detector 330 may access a CAN model describing expected traffic on the CAN 320. Across the fleet of AVs 110, each AV 110 may have the same set of CAN devices 325 connected to the CAN 320, and the traffic transmitted over the CAN 320 may be standard and well-characterized. For example, the CAN model may describe expected traffic to and/or from one or more devices (identified by CAN IDs) on the CAN 320, e.g., sender and/or recipient CAN IDs, size of data messages, rate of transmission, etc. As one particular example, the CAN model may include data indicating that, if the AV 110 is in a self-driving mode, a CAN message with a given CAN ID (e.g., ID Z) should occur with an expected frequency. If the CAN anomaly detector 330 observes data with CAN ID Z with a frequency greater than the expected frequency, this may indicate an intrusion into the CAN 320.

If the CAN anomaly detector 330 detects a change from the expected traffic patterns, the CAN anomaly detector 330 may transmit an anomaly signal to the anomaly response system 360. The anomaly signal may indicate that an anomaly was detected on the CAN 320. In some embodiments, the anomaly signal may describe the anomaly, e.g., the type of anomaly (e.g., whether unexpected network traffic was detected or expected network traffic was not observed), the device or devices involved (e.g., the device transmitting and/or receiving unexpected network traffic), the frequency and/or duration of the anomaly (e.g., whether the unusual traffic was temporary or is ongoing), or other information. In some embodiments, the CAN anomaly detector 330 may filter certain low-level anomalies, e.g., if a single expected message was not observed, but expected network traffic has resumed, the CAN anomaly detector 330 may not signal this to the anomaly response system 360. For example, the CAN anomaly detector 330 may signal the anomaly after observing at least a threshold number of dropped messages, or at least a threshold number of unexpected messages. The CAN anomaly detector 330 may have different thresholds for different types of anomalies, e.g., a lower threshold for unexpected messages to the brake controller 275, steering controller 280, or engine controller 285 than to the onboard computer 150.

The image processing anomaly detector 340 may be configured to detect an anomaly in a software process executed on the image processing computer 225. For example, the image processing anomaly detector 340 may observe data flows to and/or from the image processor 230, e.g., data flows from the image models 235 to the image processor 230, and data flows from the image processor 230 to the processing logs 240. The behavior of the image processor 230 may be predictable and well-characterized. For example, the image processor 230 may retrieve certain models or other data from the image models 235 each time it receives a new set of images from the cameras 205. The image processor 230 may update log files in the processing logs 240 at a regular cadence, e.g., every second. If the image processing anomaly detector 340 observes a change to the expected pattern of data flows, this may indicate a disruption to the image processor 230, and the image processing anomaly detector 340 may alert the anomaly response system 360. As described with respect to the network anomaly detectors 315 and 330, the image processing anomaly detector 340 may filter certain low-level anomalies, e.g., a temporary change to a data flow after which the expected data flow is restored.

The main compute anomaly detector 350 may be configured to detect an anomaly in a software process executed on the onboard computer 150. For example, the main compute anomaly detector 350 may observe data flows from or to the self-driving system 250, or some sub-process or sub-processes of the self-driving system 250. The main compute anomaly detector 350 may observe data flows to the self-driving system 250, e.g., accessing stored program instructions, accessing stored models, or accessing data from other modules, e.g., the image processing computer 225. The main compute anomaly detector 350 may additionally or alternatively observe data flows from the self-driving system 250, e.g., saves to log files, or instructions sent to the vehicle control system 270. If the main compute anomaly detector 350 observes a change to the expected pattern of data flows, this may indicate a disruption to the self-driving system 250, and the main compute anomaly detector 350 may alert the anomaly response system 360.

The anomaly response system 360 may receive an anomaly signal indicating an anomaly from any of the anomaly detectors, e.g., the Ethernet anomaly detector 315, the CAN anomaly detector 330, the image processing anomaly detector 340, or the main compute anomaly detector 350. In response to receiving an anomaly signal, the anomaly response system 360 may classify the anomaly based on data received from the anomaly detector. For example, the anomaly response system 360 may access one or more rules for classifying an anomaly. The anomaly response system 360 may classify an anomaly by, for example, anomaly type (e.g., the portion or function of the AV 110 affected, whether the anomaly was temporary or is ongoing), or the anomaly severity or risk (e.g., an expected degree of impact that the anomaly may have on the ability of the AV 110 to drive autonomously). For example, an anomaly that was temporary but appears to have been resolved may a have a lower risk than an anomaly that is ongoing. As another example, an anomaly that impacts a redundant system (e.g., a redundant sensor device) may have a lower risk than an anomaly that impacts a critical system (e.g., the lidar sensor 210, if only one lidar sensor 210 is included in the AV 110). As a further example, the anomaly response system 360 may receive anomaly signals from multiple anomaly detectors, e.g., a network anomaly from the Ethernet anomaly detector 315 and an image processing anomaly from the image processing anomaly detector 340. The anomaly response system 360 may classify the risk as being higher in response to receiving anomaly signals from multiple anomaly detectors, indicating that multiple systems may be impacted.

In response to the anomaly signal, the anomaly response system 360 may transmit an instruction to the self-driving system 250 instructing the self-driving system 250 to alter a planned path of the AV 110. The instruction may include a particular maneuver for the AV to perform, where the anomaly response system 360 may select the maneuver based on the anomaly classification. For example, the instruction may, in some cases, be an instruction for the AV 110 to stop driving immediately, or to pull over and stop, e.g., in response to a high-risk anomaly. The instruction may, in some other cases, be an instruction to return to a maintenance facility when practicable, e.g., in response to a low-risk anomaly. In some cases, the anomaly response system 360 may determine not to instruct the AV 110 to alter the planned path of the AV 110, e.g., in response to a no-risk anomaly (e.g., an anomaly that has resolved).

In some embodiments, the anomaly response system 360 determines the maneuver based at least in part on vehicle state information received from the self-driving system 250 and/or other inputs, e.g., data from the sensor suite 140. For example, the anomaly response system 360 may select a maneuver based on whether or not there is a passenger in the AV 110 (e.g., selecting a harder stop the AV 110 does not have any passengers, or selecting to return to a maintenance facility immediately if the AV 110 does not have any passengers). As another example, the anomaly response system 360 may select a type of stop (e.g., hard stop or soft stop) based on the AV 110 speed and/or current traffic conditions, e.g., selecting a harder stop if there are no vehicles traveling behind the AV 110. As noted with respect to FIG. 2, in other embodiments, these and/or other factors are considered by the self-driving system 250 in response to an instruction from the anomaly response system 360 to alter a path or perform a particular maneuver.

### Example Process for Detecting and Responding to an AV Anomaly

FIG. 4 is a flow chart of a process for detecting and responding to an anomaly on the AV, according to some embodiments of the present disclosure. The anomaly response system 360 may receive 410 an anomaly signal from an anomaly detector, e.g., any of the anomaly detectors 315, 330, 340, or 350 described with respect to FIG. 3. The anomaly detectors may detect the anomalies and transmit anomaly signals as described with respect to FIG. 3.

The anomaly response system 360 may classify 420 the anomaly based on the source of the anomaly signal (e.g., which of the anomaly detectors 315, 330, 340, or 350 transmitted the anomaly signal) and/or data in the anomaly signal. For example, the anomaly response system 360 may classify the anomaly as a particular type of anomaly, e.g., a temporary or ongoing anomaly. As another example, the anomaly response system 360 may classify the anomaly by severity, e.g., whether the anomaly may have a high impact on the self-driving functionality of the AV 110 or a low impact.

The anomaly response system 360 may determine 430 whether the AV 110 should stop driving based on the classification of the anomaly. If the anomaly response system 360 determines that the AV 110 should stop, the anomaly response system 360 may determine 440 a stop maneuver to be performed by the AV 110. For example, the anomaly response system 360 may determine that the AV 110 should continue driving and stop at a maintenance facility, or, alternatively, that the AV 110 should stop driving immediately. The anomaly response system 360 instructs 450 the self-driving system 250 to perform the maneuver. The self-driving system 250 may perform the maneuver, but may modify the maneuver based on various factors, as described with respect to FIG. 2.

The anomaly response system 360 may further alert 460 the fleet management system 120 to the anomaly and to any action taken by the AV 110 in response to the anomaly, e.g., the stop maneuver selected by the anomaly response system 360. If at decision 430 the anomaly response system 360 determines that the AV 110 should not pull over, the anomaly response system 360 may proceed directly to alerting 460 the fleet management system 120 of the anomaly.

### Select Examples

Example 1 provides an onboard security system for an AV, the onboard security system including a local network anomaly detector to detect an anomaly in traffic transmitted over a local network of the AV; a process anomaly detector to detect an anomaly in a software process executed on a computer of the AV; and an anomaly response system to receive an anomaly signal indicating an anomaly from one or more of the local network anomaly detector and the process anomaly detector; and transmit a path signal to a self-driving system of the AV based on the anomaly, the path signal instructing the self-driving system to alter a planned path of the AV.

Example 2 provides the onboard security system of example 1, where the local network of the AV is an Ethernet network, and a plurality of sensor systems transmit traffic over the Ethernet network.

Example 3 provides the onboard security system of example 1, where the local network of the AV is a CAN, and a plurality of vehicle controllers receive traffic over the CAN.

Example 4 provides the onboard security system of example 1, further including a second local network anomaly detector to detect an anomaly in traffic transmitted over a second local network of the AV, where the anomaly response system receives an anomaly signal indicating the anomaly from one or more of the local network anomaly detector, the process anomaly detector, and the second local network anomaly detector.

Example 5 provides the onboard security system of example 1, where the local network anomaly detector is to observe traffic traversing the local network; compare the observed traffic to a model describing expected traffic, the model including one or more of data traffic rates, expected network addresses, or expected network identifiers on the local network; and detect an anomaly based on the observed traffic differing from the model describing expected traffic.

Example 6 provides the onboard security system of example 1, where the process anomaly detector detects an anomaly in a software process based on data flows to and from the software process.

Example 7 provides the onboard security system of example 1, where the anomaly response system is further to classify the anomaly based on the anomaly signal received from the local network anomaly detector or the process anomaly detector; and determine, based on the classified anomaly, a maneuver for the AV to perform, where the maneuver alters the planned path of the AV.

Example 8 provides the onboard security system of example 7, where classifying the anomaly includes comparing the anomaly to a set of anomaly types, where a first type of the anomaly types has a greater associated risk than a second type of the anomaly types, and the anomaly response system determines not to instruct the AV to alter the planned path of the AV in response to detecting an anomaly of the second type.

Example 9 provides the onboard security system of example 7, where the anomaly response system is further to receive vehicle state information from the self-driving system; determine, based on the vehicle state information, the maneuver for the AV to perform; and transmit a maneuver signal indicating the determined maneuver to the self-driving system.

Example 10 provides the onboard security system of example 7, where the self-driving system is to receive a signal indicating the determined maneuver from the anomaly response system; determine, based on data from at least one environmental sensor describing the environment of the AV, that the AV can perform the determined maneuver; and in response to determining that the AV can perform the determined maneuver, instruct at least one vehicle control system of the AV to perform the determined maneuver.

Example 11 provides the onboard security system of example 7, where the anomaly response system is to determine the maneuver based in part on whether a passenger is riding in the AV.

Example 12 provides a method for stopping an AV in response to detecting an onboard anomaly, the method including receiving, from one of a plurality of anomaly detectors, an anomaly signal indicating a detected anomaly, the plurality of anomaly detectors including one of a network anomaly detector to detect an anomaly on a local network of the AV and a process anomaly detector to detect an anomaly in a software process of the AV; classifying the anomaly based on the received anomaly signal indicating the detected anomaly; and transmitting a path signal to a self-driving system of the AV based on the anomaly, the path signal instructing the self-driving system to alter a planned path of the AV.

Example 13 provides the method of example 12, where the local network of the AV is an Ethernet network, and a plurality of sensor systems transmit traffic over the Ethernet network.

Example 14 provides the method of example 12, where the local network of the AV is a CAN, and a plurality of vehicle controllers receive traffic over the CAN.

Example 15 provides the method of example 12, further including observing, by the network anomaly detector, traffic traversing the local network comparing the observed traffic to a model describing expected traffic, the model including one or more of data traffic rates, expected network addresses, or expected network identifiers on the local network; and detecting the anomaly in response to the observed traffic differing from the model describing expected traffic.

Example 16 provides the method of example 12, where the process anomaly detector detects an anomaly in a software process based on data flows to and from the software process.

Example 17 provides the method of example 12, further including determining, based on the classified anomaly, a maneuver for the AV to perform, where the maneuver alters the planned path of the AV.

Example 18 provides the method of example 17, further including receiving, at the self-driving system, a signal indicating the determined maneuver; determining, based on data from at least one environmental sensor describing the environment of the AV, that the AV can perform the determined maneuver; and in response to determining that the AV can perform the determined maneuver, instructing at least one vehicle control system of the AV to perform the determined maneuver.

Example 19 provides a non-transitory computer-readable medium storing instructions for stopping an AV in response to detecting an onboard anomaly, the instructions, when executed by a processor, cause the processor to receive, from one of a plurality of anomaly detectors, an anomaly signal indicating a detected anomaly, the plurality of anomaly detectors including one of a network anomaly detector to detect an anomaly on a local network of the AV and a process anomaly detector to detect an anomaly in a software process of the AV; classify the anomaly based on the received anomaly signal indicating the detected anomaly; and transmit a path signal to a self-driving system of the AV based on the anomaly, the path signal instructing the self-driving system to alter a planned path of the AV.

Example 20 provides the computer-readable medium of example 19, where the instructions further cause the processor to determine, based on the classified anomaly, a maneuver for the AV to perform, where the maneuver alters the planned path of the AV.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. An onboard security system for an autonomous vehicle (AV), the onboard security system comprising:
a local network anomaly detector to detect an anomaly in traffic transmitted over a local network of the AV;
a process anomaly detector to detect an anomaly in a software process executed on a computer of the AV; and
an anomaly response system to:
receive an anomaly signal indicating an anomaly from one or more of the local network anomaly detector and the process anomaly detector; and
transmit a path signal to a self-driving system of the AV based on the anomaly, the path signal instructing the self-driving system to alter a planned path of the AV.

2. The onboard security system of claim 1, wherein the local network of the AV is an Ethernet network, and a plurality of sensor systems transmit traffic over the Ethernet network.

3. The onboard security system of claim 1, wherein the local network of the AV is a control area network (CAN), and a plurality of vehicle controllers receive traffic over the CAN.

4. The onboard security system of claim 1, wherein the local network anomaly detector is a first local anomaly detector, the system further comprising a second local network anomaly detector to detect an anomaly in traffic transmitted over a second local network of the AV, wherein the anomaly response system receives an anomaly signal indicating the anomaly from one or more of the first local network anomaly detector, the process anomaly detector, and the second local network anomaly detector.

5. The onboard security system of claim 1, wherein the local network anomaly detector is to:
observe traffic traversing the local network;
compare the observed traffic to a model describing expected traffic, the model comprising one or more of expected data traffic rates, expected network addresses, or expected network identifiers on the local network; and
detect an anomaly based on the observed traffic differing from the model describing expected traffic.

6. The onboard security system of claim 1, wherein the process anomaly detector detects an anomaly in a software process based on data flows to and from the software process.

7. The onboard security system of claim 1, wherein the anomaly response system is further to:
classify the anomaly based on the anomaly signal received from the local network anomaly detector or the process anomaly detector; and
determine, based on the classified anomaly, a maneuver for the AV to perform, wherein the maneuver alters the planned path of the AV.

8. The onboard security system of claim 7, wherein classifying the anomaly comprises comparing the anomaly to a set of anomaly types, wherein a first type of the anomaly types has a greater associated risk than a second type of the anomaly types, and the anomaly response system determines not to instruct the AV to alter the planned path of the AV in response to detecting an anomaly of the second type.

9. The onboard security system of claim 7, wherein the anomaly response system is further to:
receive vehicle state information from the self-driving system;
determine, based on the vehicle state information, the maneuver for the AV to perform; and
transmit a maneuver signal indicating the determined maneuver to the self-driving system.

10. The onboard security system of claim 7, wherein the self-driving system is to:
receive a signal indicating the determined maneuver from the anomaly response system;
determine, based on data from at least one environmental sensor describing the environment of the AV, that the AV can perform the determined maneuver; and
in response to determining that the AV can perform the determined maneuver, instruct at least one vehicle control system of the AV to perform the determined maneuver.

11. The onboard security system of claim 7, wherein the anomaly response system is to determine the maneuver based in part on whether a passenger is riding in the AV.

12. A method for stopping an autonomous vehicle (AV) in response to detecting an onboard anomaly, the method comprising:
receiving, from one of a plurality of anomaly detectors, an anomaly signal indicating a detected anomaly, the plurality of anomaly detectors comprising one of a network anomaly detector to detect an anomaly on a local network of the AV and a process anomaly detector to detect an anomaly in a software process of the AV;
classifying the anomaly based on the received anomaly signal indicating the detected anomaly; and
transmitting a path signal to a self-driving system of the AV based on the anomaly, the path signal instructing the self-driving system to alter a planned path of the AV.

13. The method of claim 12, wherein the local network of the AV is an Ethernet network, and a plurality of sensor systems transmit traffic over the Ethernet network.

14. The method of claim 12, wherein the local network of the AV is a control area network (CAN), and a plurality of vehicle controllers receive traffic over the CAN.

15. The method of claim 12, further comprising:
observing, by the network anomaly detector, traffic traversing the local network;
comparing the observed traffic to a model describing expected traffic, the model comprising data traffic rates, expected network addresses, or expected network identifiers on the local network; and
detecting the anomaly in response to the observed traffic differing from the model describing expected traffic.

16. The method of claim 12, wherein the process anomaly detector detects an anomaly in a software process based on data flows to and from the software process.

17. The method of claim 12, further comprising:
determining, based on the classified anomaly, a maneuver for the AV to perform, wherein the maneuver alters the planned path of the AV.

18. The method of claim 17, further comprising:
receiving, at the self-driving system, a signal indicating the determined maneuver;
determining, based on data from at least one environmental sensor describing the environment of the AV, that the AV can perform the determined maneuver; and
in response to determining that the AV can perform the determined maneuver, instructing at least one vehicle control system of the AV to perform the determined maneuver.

19. A non-transitory computer-readable medium storing instructions for stopping an autonomous vehicle (AV) in response to detecting an onboard anomaly, the instructions, when executed by a processor, cause the processor to:
receive, from one of a plurality of anomaly detectors, an anomaly signal indicating a detected anomaly, the plurality of anomaly detectors comprising one of a network anomaly detector to detect an anomaly on a local network of the AV and a process anomaly detector to detect an anomaly in a software process of the AV;
classify the anomaly based on the received anomaly signal indicating the detected anomaly; and
transmit a path signal to a self-driving system of the AV based on the anomaly, the path signal instructing the self-driving system to alter a planned path of the AV.

20. The computer-readable medium of claim 19, wherein the instructions further cause the processor to:
determine, based on the classified anomaly, a maneuver for the AV to perform, wherein the maneuver alters the planned path of the AV.
